(19) United States
(12) Patent Application Publication
(10) Pub. No.: US 2022/0411060 A1
(43) Pub. Date: Dec. 29, 2022

(54) STOWABLE AIRCRAFT LIFT

(71) Applicant: Steelman Aviation, Inc., Las Vegas, NV (US)

(72) Inventors: Christopher L. Honea, Las Vegas, NV (US); Tommy R. Suell, North Las Vegas, NV (US); Paul C. Steelman, Las Vegas, NV (US)

(21) Appl. No.: 17/848,349

(22) Filed: Jun. 23, 2022

Related U.S. Application Data
(60) Provisional application No. 63/214,154, filed on Jun. 23, 2021.

(51) Int. Cl. B64D 9/00; A61G 3/06

(52) U.S. Cl. CPC B64D 9/00; A61G 3/062

(57) ABSTRACT

A lift for aircraft, such as a passenger lift, facilitates the entry of disabled passengers and/or items into the cabins of aircraft and their exit from the cabins of the aircraft. The lift may be stowed and used from within the cabin of the aircraft. Methods accessing a cabin of an aircraft and methods for facilitating the introduction of passengers and/or items into the cabin and their removal from the cabin are also disclosed.

### CROSS-REFERENCE TO RELATED APPLICATION

A claim for priority to the Jun. 23, 2021 filing date of U.S. Provisional Patent Application No. 63/214,154, titled STOWABLE AIRCRAFT LIFT (“the ′154 Provisional Application”), is hereby made pursuant to 35 U.S.C. § 119(e). The entire disclosure of the ′154 Provisional Application is hereby incorporated herein.

### TECHNICAL FIELD

This disclosure relates generally to lifts for aircraft and, more specifically, to passenger lifts that facilitate the entry of disabled passengers into the cabins of aircraft and their exit from the cabins of the aircraft. Even more specifically, this disclosure relates to lifts that may be stowed and used from within the cabin of the aircraft. In addition, this disclosure relates to methods for accessing a cabin of an aircraft, or to methods for facilitating the introduction of passengers and/or items into the cabin and their removal from the cabin.

### SUMMARY

In one aspect, embodiments of lifts for aircraft are disclosed. Such a lift includes a base, one or more lift hinges, one or more elongated lift legs, and a deck. In some embodiments, a lift may include a pair of lift hinges and a corresponding pair of elongated lift legs.

The base may removably couple to the aircraft, within a cabin of the aircraft, adjacent to a door (e.g., a cargo door, etc.) of the aircraft. The base may removably couple to a seat mounting structure within a floor of the cabin of the aircraft at a location adjacent to a door of the aircraft.

Each lift hinge of the lift is pivotally coupled to the base. Each lift hinge may pivot between a stowed position and a deployed position. The stowed position of each lift hinge may position the lift, while in a stowed arrangement, within the cabin of the aircraft. The deployed position of each lift hinge may position the lift, while in a deployed arrangement, outside of the aircraft, adjacent to the door of the aircraft.

Each lift hinge may include a limiting edge or surface, which may rest against the floor of the aircraft when the lift hinge is pivoted to its stowed position. The limiting edge or surface may limit the extent to which the lift hinge may be pivoted to its deployed position, preventing a remainder of the lift, while in its stowed arrangement, from impacting or even contacting the bulkhead of the aircraft. Each lift hinge may also include a weight-bearing edge or surface, which may enable the lift hinge, when pivoted to the deployed position, to rest against the floor and/or a portion of the fuselage of the aircraft located at a base of a door opening of the aircraft. The weight-bearing edge or surface may at least partially bear the weight of the lift and any individuals and/or items supported by the deck of the lift.

Each lift hinge includes a lift leg receptacle, which receives a portion of a length of an elongated lift leg of the lift. When each lift hinge is pivoted to the stowed position, the lift leg receptacle may be oriented to enable the elongated lift leg to be positioned within the cabin of the aircraft, or substantially horizontally. When each lift hinge is pivoted to the deployed position, the lift leg receptacle may be oriented to enable the elongated lift leg to be positioned outside the door of the aircraft.

Each elongated lift leg may be assembled with the lift leg receptacle of its corresponding lift hinge. The manner in which the elongated lift leg is assembled with the lift hinge may enable the elongated lift leg to be selectively retracted to a stowed position, in which a bottom portion of the elongated lift leg is located within the lift leg receptacle, and selectively extended to a deployed position, in which a top portion of the elongated lift leg resides within the lift leg receptacle. The elongated lift leg may be secured, or locked into, its stowed position and/or its deployed position.

In some embodiments, the elongated lift leg may slide through the lift leg receptacle. Such sliding movement may be facilitated (e.g., with bearings, rollers, wheels, etc.) in a manner that reduces friction between the left leg receptacle and the elongated lift leg; thus, the elongated lift leg may move substantially freely through the lift leg receptacle.

Each elongated lift leg may include a lift drive. When the elongated lift leg is in its deployed position, for example, extending from a location adjacent to a bottom of the door opening of the aircraft (e.g., just above, even with, or just below the bottom of the door opening, etc.), the lift drive may facilitate movement of the deck along the length of the elongated lift leg, between the bottom of the door opening and the tarmac.

The deck of the lift may include a carriage, which may support a disabled individual, an object or the like. In addition, the deck may include a lift leg coupler assembled with each elongated lift leg, as well as a platform carried by the lift leg coupler. In embodiments where the lift includes a pair of lift hinges and a pair of elongated lift legs, the deck of the lift may include a pair of lift leg couplers, with each lift leg coupler of the pair of lift leg couplers being assembled with a corresponding elongated lift leg of the pair of elongated lift legs.

Each lift leg coupler may at least partially receive a portion of its corresponding elongated lift leg. For example, each lift leg coupler may include a lift leg receptacle that receives the elongated lift leg and selectively travels along a length of the elongated lift leg. In addition, each lift leg coupler may include a lift drive engager that engages the lift drive of the elongated lift leg that corresponds to the lift leg coupler. In some embodiments, the lift drive engager of the lift leg coupler may selectively engage and disengage the lift drive of the elongated lift leg. Such a lift leg coupler may be disengaged from the lift drive engager when the elongated lift leg is in its stowed position and engage the lift drive engager when the elongated lift leg is in its deployed orientation.

The platform of the deck may be pivotally coupled to each lift leg coupler. The platform may, therefore, pivot between a stowed position and a deployed position. While in its stowed position, the platform may be folded against each elongated lift leg of the lift, or oriented substantially parallel to each elongated lift leg. While in the deployed position, the platform may be oriented transverse to (e.g., substantially perpendicular to, at an angle of about 90° to 120° to, etc.) each elongated lift leg.

In embodiments where the deck includes a pair of lift leg couplers, the deck may extend between the pair of lift leg couplers. Side edges of the deck may extend to outer edges of the lift leg couplers and their corresponding elongated lift legs. Alternatively, side edges of the deck may extend beyond the outer edges of the lift leg couplers and their corresponding elongated lift legs.

Optionally, the deck of the lift may include a ramp. The ramp may be pivotally associated with the platform. More specifically, the ramp may pivot between a stowed position and a deployed position. When the ramp is in its stowed position, it may be folded over the platform, or positioned substantially parallel to the platform. When in its deployed position, the ramp may be oriented to extend from a front edge of the platform and thus, extend from the front edge of the platform. A configuration of the ramp may provide a transition between a surface against which the platform is positioned and an upper surface of the platform as the platform is lowered to the tarmac.

The lift may include a motor that operates the lift drive of each elongated lift leg. In some embodiments, a transfer case may couple the motor to the lift drive of each elongated lift leg. In embodiments where the lift includes a pair of elongated lift legs, the transfer case may enable the motor to simultaneously drive the lift drives of the pair of elongated lift legs. The transfer case may enable the motor to synchronously drive the lift drives. In such embodiments, the motor and the transfer case may be positioned between the elongated lift legs, adjacent to bases thereof. While the lift is in its deployed arrangement and each lift drive engager of each lift leg coupler of the deck engages its corresponding lift drive, the motor and transfer case, if any, of the lift may move the platform and optional ramp up and down along the elongated lift legs. When placing the lift in its stowed arrangement, with each lift drive engager of each lift hinge engaging its corresponding lift drive, the motor and transfer case, if any, may operate each lift drive to move each elongated lift leg from its deployed position to its stowed position. In some embodiments, the motor may operate under power from the aircraft.

A lift according to this disclosure may have a stowed arrangement. While in the stowed arrangement, each lift hinge may be in its stowed position, each elongated lift leg may be in its stowed position, the deck may be in its stowed position, and the optional ramp may be in its stowed position. When placed in the stowed arrangement, the lift may be reside within the cabin of an aircraft, for example, at a location just inside a door of the aircraft. The stowed arrangement of the lift may enable the lift to be stored within the cabin, for example, just inside the door of the aircraft, and enable the adjacent door to be closed. The stowed arrangement of the lift may also facilitate removal of the lift from the cabin of the aircraft through the door.

A lift according to this disclosure may also have a deployed arrangement. While in the deployed arrangement, each lift hinge may be in its deployed position, each elongated lift leg may be in its deployed position, the deck may be in its deployed position, and the optional ramp may be in its deployed position. When placed in the deployed arrangement, each elongated lift leg and the deck may be located outside of the aircraft, with the elongated lift leg extending from a location adjacent to a bottom of a door opening to the tarmac. The deployed arrangement of the lift may enable the lift to be used to enable a disabled passenger to enter and exit the cabin. Likewise, the deployed arrangement of the lift may facilitate the introduction of cargo into the cabin and/or the removal of cargo from the cabin.

In another aspect, methods for accessing a cabin of an aircraft are disclosed. Such a method may include installing a lift within a cabin of the aircraft, just inside a door of the aircraft (e.g., a cargo door, etc.). More specifically, a base of the lift may be removably or releasably coupled to a floor of the aircraft, just inside the door. Even more specifically, the base of the lift may be removably coupled to a seat mounting structure on the floor of the aircraft.

Such a method also includes deploying the lift from within the cabin of the aircraft through the door of the aircraft. Deployment of the lift may include pivoting each lift hinge of the lift from a stowed position relative to a floor of the cabin of the aircraft and the door of the aircraft to a deployed position relative to the floor and the door. In addition, each elongated lift leg of the lift may be extended its corresponding lift hinge from a stowed position within the cabin of the aircraft to a deployed position outside of the door of the aircraft. The carriage of the deck of the lift may be pivoted from a stowed position substantially against each elongated lift leg to a deployed position extending transversely from each elongated lift leg. The optional ramp may be pivoted from a stowed position in which the ramp is at least partially superimposed with the carriage to a deployed position in which the ramp extends from the carriage. The optional ramp may be locked in its deployed position.

With each lift hinge pivoted to its deployed position, each elongated lift leg extended to its deployed position, and the deck of the lift pivoted to its deployed position, the deck may be raised and/or lowered along the elongated lift leg(s). Raising and lowering of the deck may be performed under power from the aircraft.

Once use of the lift is complete, the lift may be stowed. Stowing the lift may include lowering the deck along the elongated lift leg(s), pivoting the optional ramp of the deck to its stowed position, and pivoting the carriage of the deck to its stowed position. In addition, each elongated lift leg may be retracted through its corresponding lift hinge, moving the elongated lift leg from its deployed position to its stowed position. Each lift hinge may also be pivoted from its deployed position to its stowed position. Once these acts are complete, the lift is in its stowed arrangement. The lift may be secured in the stowed arrangement. The door of the aircraft may be closed. With the lift in its stowed arrangement, the aircraft may be used to travel to any destination, where the lift can be readily deployed to facilitate loading and/or unloading of the aircraft at the destination.

Other aspects of the disclosed subject matter, as well as features and advantages of various aspects of the disclosed subject matter, should be apparent to those of ordinary skill in the art through consideration of the foregoing disclosure, the information that follows, and the appended claims.

### BRIEF DESCRIPTION OF THE DRAWINGS

In the drawings:

FIG. 1 shows an embodiment of a lift for an aircraft in a stowed arrangement within the cabin of the aircraft, just inside a cargo door of the aircraft;

FIG. 2 depicts the embodiment of the lift of FIG. 1 from inside the cabin of the aircraft in a deployed arrangement with a deck of the lift a raised position;

FIG. 3 illustrates the embodiment of the lift of FIG. 1 in the deployed arrangement shown in FIG. 2 from outside the aircraft, with the deck in a lowered position;

FIG. 4 shows an embodiment of use of the embodiment of the lift of FIGS. 1-3 being used to assist a disabled individual as he or she enters or exits the cabin of the aircraft;

FIG. 5 is a perspective view of an embodiment of a motor and a transfer case of the embodiment of the lift of FIGS. 1-3;

FIG. 6 is an enlarged perspective view of the portion of the transfer case shown in circle A of FIG. 5; and

FIG. 7 is an enlarged transparent perspective view of an end the transfer case shown in FIG. 5.

### DETAILED DESCRIPTION

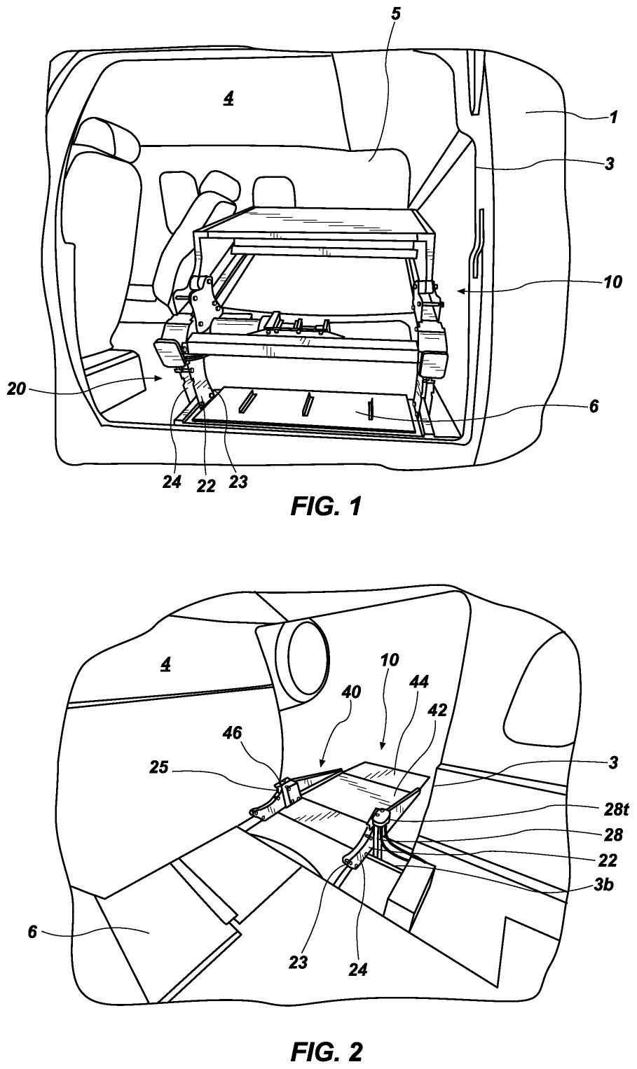

With reference to FIGS. 1-4, an embodiment of a lift 10 for an aircraft 1 is depicted. The lift 10 includes lift hinges 22, elongated lift legs 28, and a deck 40, as well as a motor 30 and a transfer case 32. The lift hinges 22 may engage complementary features (e.g., a seat mounting structure, etc.) within a floor of the cabin of the aircraft within a floor 6 of a cabin 4 of the aircraft 1 at a location adjacent to a door 3 of the aircraft 1. The elongated lift legs 28 are located atop the lift hinges 22. The deck 40 is carried by, travels along the lengths of, and pivots relative to the elongated lift legs 28. The motor 30 and transfer case 32 are associated with the elongated lift legs 28 in a manner that enables them to selectively move the deck 40 along the lengths of the elongated lift legs 28.

In FIG. 1, the lift 10 is shown from outside of the aircraft 1, through a door 3 (e.g., a cargo door, etc.) of the aircraft 1. FIG. 1 shows the lift 10 in a stowed arrangement within a cabin 4 of the aircraft 1, just inside the door 3. A base 20 of the lift 10 is removably secured to a floor 6 of the aircraft 1.

Lift hinges 22 protrude from the base 20 and are pivoted to stowed positions, with limiting edges or surfaces 23 of the lift hinges 22 resting against the floor 6 of the aircraft 1. Elongated lift legs 28 are located atop the lift hinges 22 and are retracted into stowed positions. A motor 30 and a transfer case 32 are located between bottom portions of the elongated lift legs 28. The deck 40 of the lift 10 is folded into a stowed position over the elongated lift legs 28. As illustrated, the orientation of the limiting edges or surfaces 23 of the lift hinges 22 may position the lift 10 in a somewhat inclined orientation to prevent the lift 10 from contacting and potentially impacting or even contacting the bulkhead 5 of the aircraft 1.

FIG. 2 shows the lift 10 from inside the cabin 4 of the aircraft 1 in a deployed arrangement. The lift hinges 22 are shown in deployed positions, in which weight-bearing edges or surfaces 24 of the lift hinges 22 are positioned against the floor 6 and, optionally, against a portion of the fuselage 2 that forms the base 3b of an opening of a door 3 (e.g., a cargo door opening, etc.) of the aircraft 1. Thus, weight-bearing edge or surfaces 24 may at least partially bear the weight of the lift 10 and any individuals and/or items supported by the deck 40 of the lift 10. The elongated lift legs 28 and the deck 40, including its carriage 42 and an optional ramp 44, are also shown in their respective deployed positions, with the deck 40 in a raised position above the ground G.

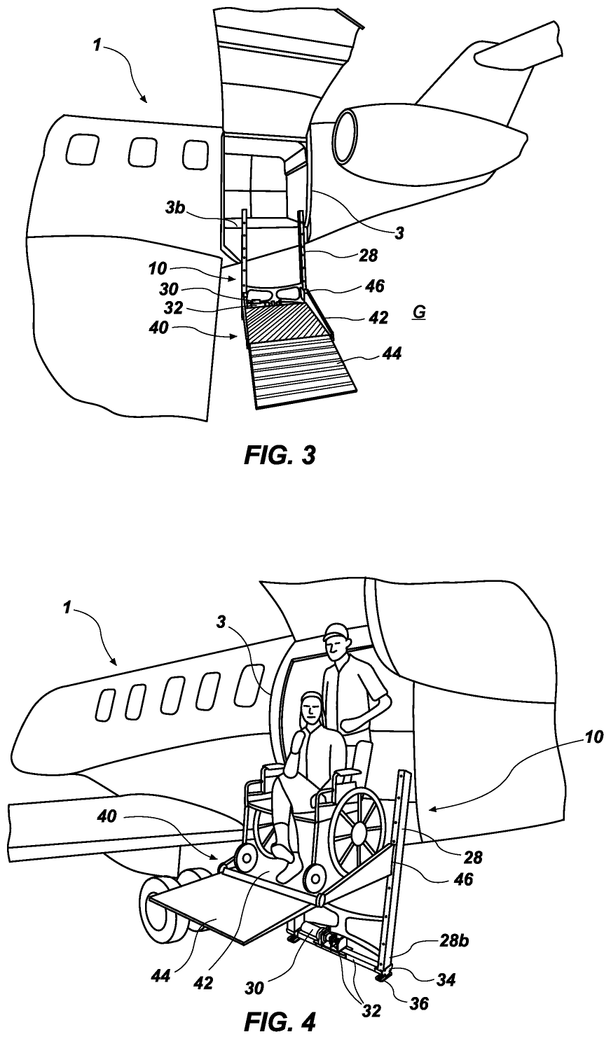

Turning now to FIG. 3, the lift 10 is illustrated in its deployed arrangement from outside the aircraft 1. The elongated lift legs 28 and the deck 40, including its carriage 42 and its optional ramp 44, are shown in their deployed positions, with the deck 40 in a lowered position on the ground G. The motor 30 and transfer case 32 of the lift 10 are located between bottom portions 28b of the elongated lift legs 28.

FIG. 4 shows the deck 40 of the lift 10 in a partially raised or partially lowered position relative to the ground G. FIG. 4 also shows an embodiment of use of the lift 10. More specifically, FIG. 4 shows the lift 10 being used to assist a disabled individual I as she enters or exits the cargo door 3 to the cabin 4 of the aircraft 1.

With returned reference to FIG. 2, each lift hinge 22 includes a lift leg receptacle 25, which receives a portion of a length of an elongated lift leg 28 of the lift 10. Each elongated lift leg 28 may be received by or otherwise assembled with the lift leg receptacle 25 of its corresponding lift hinge 22. The manner in which the elongated lift leg 28 is assembled with the lift hinge 22 may enable the elongated lift leg 28 to be selectively retracted to a stowed position, as shown in FIG. 1, in which a bottom portion of the elongated lift leg 28b is located within the lift leg receptacle 25, and selectively extended to a deployed position, as shown in FIG. 2, in which a top portion 28t of the elongated lift leg 28 resides within the lift leg receptacle 25. The elongated lift leg 28 may be secured, or locked into, its stowed position and/or its deployed position.

When each lift hinge 22 is pivoted to the stowed position shown in FIG. 1, the lift leg receptacle 25 may be oriented to enable the elongated lift leg 28 to be positioned within the cabin 4 of the aircraft 1, or substantially horizontally. When each lift hinge 22 is pivoted to the deployed position shown in FIG. 2, the lift leg receptacle 25 may be oriented to enable the elongated lift leg 28 to be positioned in a substantially vertical orientation outside the door 3 of the aircraft 1.

In some embodiments, the elongated lift leg 28 may slide through the lift leg receptacle 25 to enable movement of the lift 10 and the lift legs 28 between the stowed positions shown in FIG. 1 and the deployed positions shown in FIGS. 2-4. Such sliding movement may be facilitated (e.g., with bearings, rollers, wheels, etc.) in a manner that reduces friction between the left leg receptacle 25 and the elongated lift leg 28; thus, the elongated lift leg 28 may move substantially freely through the lift leg receptacle 25. In other embodiments, each elongated lift leg 28 may be driven through its corresponding lift leg receptacle 25.

As shown in FIG. 4, in addition to the carriage 42 and optional ramp 44, the deck 40 of the lift 10 includes one or more lift leg couplers 46. Each lift leg coupler 46 engages (e.g., receives, etc.) and travels along a length of its corresponding elongated lift leg 28. Each lift leg coupler 46 may include a lift drive engager (e.g., a female member with internal helically arranged threads, etc.), which enables a lift drive (e.g., a large, helically threaded male member, such as a screw, etc.) within an elongated lift leg 28 to move its corresponding lift leg coupler 46 and, thus, the deck 40 along the length of the elongated lift leg 28.

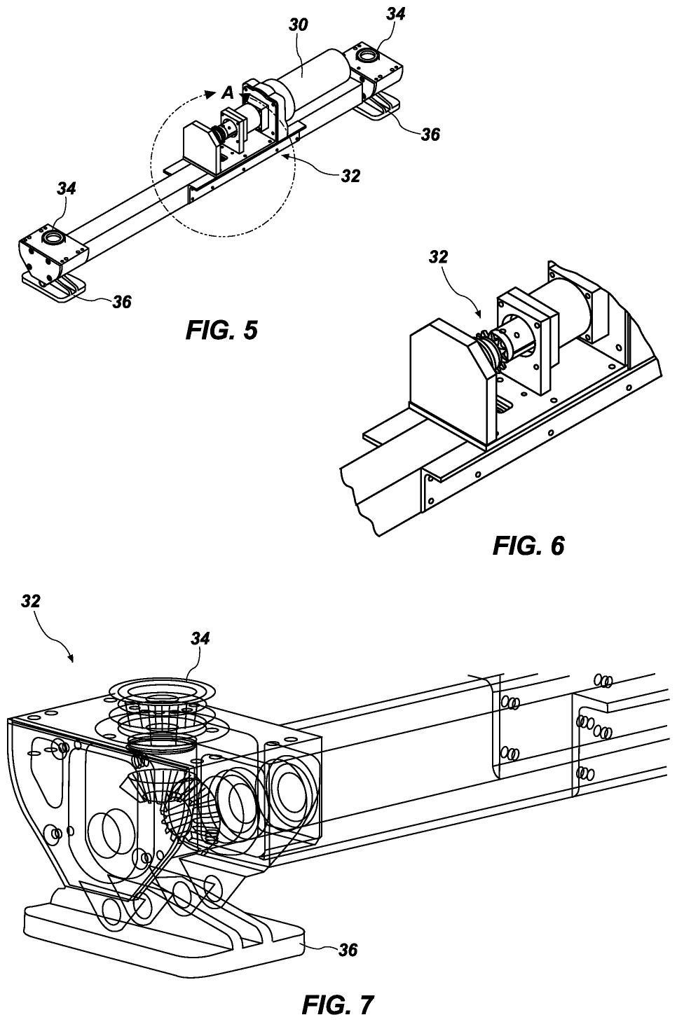

The manner in which the deck 40 is moved along the length of each elongated lift leg 28 will now be described in reference to FIGS. 5-7. FIGS. 5-7 show embodiments of an assembly including the motor 30 and transfer case 32 of the lift 10. The assembly may also include feet 36 (see also FIG. 4), which may be configured to contact the ground G (FIG. 4) and to partially support the lift 10 while in its deployed arrangement. The assembly including the motor 30 and transfer case 32 may be positioned between the elongated lift legs 28 of the lift 10, at the bottom ends 28b of the elongated lift legs 28 (see FIGS. 3 and 4).

The motor 30 and transfer case 32 enable the deck 40 to be raised and lowered along the elongated lift legs 28 when the elongated lift legs 28 are in their deployed positions (see FIGS. 2-4). The motor 30, when actuated, operates the transfer case 32. The transfer case 32, in turn, transfers power from the motor 30 to at least one coupler 34 (two are shown in FIG. 5) in a manner that rotates each coupler 34. Each coupler 34 receives the bottom end 28b of an elongated lift leg 28 in a manner that engages an end of a lift drive of (e.g., within, etc.) the elongated lift leg 28 in such a way that, when the motor 30 and transfer case 32 operate, the coupler 34 rotates the lift drive.

The lift drive of the elongated lift leg 28 is engaged by a lift drive engager of each lift leg coupler 46 of the deck 40. As the motor 30 and transfer case 32 turn the coupler 34 and the lift drive of the elongated lift leg 28, the corresponding lift leg engager 46 of the deck 40 and, thus, the deck 40, are driven along the length of the elongated lift leg 28.

The carriage 42 of the deck 40 may pivot relative to each lift leg engager 46. Such an arrangement may enable the deck 40 to fold over the lift legs 28 when the lift 10 is in the stowed arrangement, as shown in FIG. 1 and to pivot outwardly so that it protrudes from the lift legs 28 when the lift is in the deployed arrangement, as shown in FIGS. 2-4.

The optional ramp 44 of the deck 40 may pivot relative to or be extendable relative to the carriage 42 of the deck 40. When pivoted or extended to a deployed arrangement relative to the carriage 42, the ramp 44 may effectively extend the length of the carriage. The ramp 44 may also impart the deck 40 with flexibility that the carriage 42 lacks. For example, the ramp 44 may provide a smooth transition between an uneven surface and the carriage 42.

In addition to moving the deployed deck 40 along the length of a lift leg 28 when the lift 10 is in its deployed arrangement, the motor 30, transfer case 32, each coupler 34, the lift drive within each elongated lift leg 28, and the lift drive engager of each the lift leg coupler 46 may move a lift leg 28 through each lift leg coupler 46 to a position beneath the folded deck 40 when the lift 10 is in its stowed arrangement (see FIG. 1). In some embodiments, a lift drive engager of each lift leg coupler 46 may selectively engage and disengage the lift drive of a corresponding elongated lift leg 28, which may enable the elongated lift leg 28 to slide through its corresponding lift leg coupler 46 when the lift 10 is in its stowed arrangement.

With returned reference to FIGS. 1-4, the lift 10 may be deployed from within the cabin 4 of the aircraft 1 through the door 3 of the aircraft 3. Deployment of the lift 10 may include extending each elongated lift leg 28 of the lift 10 through a receptacle 25 of its corresponding lift hinge 22 to move each elongated lift leg 28 from a stowed position to a deployed position. Each lift hinge 22 of the lift 10 may be pivoted from a stowed position relative to a floor 5 of the cabin 4 and the door 3 to a deployed position relative to the floor 5 and the door 3. The carriage 42 of the deck 40 of the lift 10 may be pivoted from a stowed position substantially against, or superimposed with, each elongated lift leg 28 to a deployed position extending transversely from each elongated lift leg 28. If the deck 40 includes a ramp 44, the ramp 44 may be pivoted from a stowed position in which the ramp 44 is folded over or otherwise superimposed with the carriage 42 to a deployed position in which the ramp 44 extends from the carriage 42. The ramp may 44 be locked in its deployed position. In some embodiments, each elongated lift leg 28 may move automatically from its stowed position to its deployed position as the deck of

With each lift hinge 22 pivoted to its deployed position, each elongated lift leg 28 extended to its deployed position, and the deck 40 of the lift 10 pivoted to its deployed position, the deck 40 may be raised and/or lowered along the elongated lift leg(s) 28. Raising and lowering of the deck 40 may be performed under power from the aircraft 1.

Once use of the lift 10 is complete, the lift 10 may be stowed. Stowing the lift 10 may include lowering the deck 40 along each elongated lift leg 28, pivoting the optional ramp 44 of the deck 40 to its stowed position, and pivoting the carriage 42 of the deck 40 to its stowed position. In addition, each elongated lift leg 28 may be retracted through the receptacle 25 of its corresponding lift hinge 22, moving the elongated lift leg 28 from its deployed position to its stowed position. Each lift hinge 22 may also be pivoted from its deployed position to its stowed position. Once these acts are complete, the lift 10 is in its stowed arrangement. The lift 10 may be secured in the stowed arrangement. The door 3 of the aircraft may be closed. With the lift 10 in its stowed arrangement, the aircraft 1 may be used to travel to any destination, where the lift 10 can be readily deployed to facilitate loading and/or unloading of the aircraft 1 at the destination.

Although the foregoing description provides many specifics, these should not be construed as limiting the scope of any of the appended claims, but merely as providing information pertinent to some specific embodiments that may fall within the scope of one or more of the appended claims. Thus, other embodiments may also lie within the scopes of the appended claims. Features from different embodiments may also be employed in combination. All additions to, deletions from, combinations of, and modifications to the disclosed subject matter that fall within the scopes of the claims are to be embraced by the claims.

What is claimed:

1. A lift for an aircraft, comprising:
a base that removably couples to the aircraft, adjacent to a cargo door of the aircraft;
a pair of lift hinges pivotally coupled to the base and spaced apart from one another, each lift hinge of the pair of lift hinges:
including a lift leg receptacle;
having a stowed position in which the lift leg receptacle is substantially horizontally oriented; and
having a deployed position in which the lift leg receptacle is substantially vertically oriented;
a pair of elongated lift legs assembled with the pair of lift hinges, each elongated lift leg of the pair of elongated lift legs:
received by the lift leg receptacle of a the lift hinge with which the lift is assembled such that the elongated lift leg is movable lengthwise through the lift leg receptacle; and
including a lift drive;
a deck including:
a pair of lift leg couplers assembled with the pair of elongated lift legs, each lift leg coupler of the pair of lift leg couplers:
including a lift leg receptacle that receives the elongated lift leg and selectively travels along a length of the elongated lift leg; and
including a lift drive engager that engages the lift drive of the elongated lift leg that corresponds to the lift leg coupler; and
a platform carried by and pivotally coupled to the pair of lift leg couplers, the platform having a stowed position in which the platform is oriented substantially parallel to the pair of elongated lift legs and a deployed position in which the platform is oriented transverse to the pair of elongated lift legs.

2. The lift of claim 1, having:
a stowed arrangement in which each lift hinge is in the stowed position and the deck is in the stowed position, the stowed arrangement facilitating introduction of the lift into a cabin of the aircraft, enabling storage of the lift within the cabin of the aircraft, enabling closure of a door of the aircraft, and facilitating removal of the lift from the cabin of the aircraft; and
a deployed arrangement in which each lift hinge is in the deployed position and the deck is in the deployed position, the deployed arrangement enabling use of the lift to facilitate entry into and exit from the cabin of the aircraft.

3. The lift of claim 1, wherein the deck further includes:
a ramp pivotally associated with the platform, the ramp having a stowed position in which the ramp is folded over the platform and a deployed position in which the ramp is oriented to extend from the platform.

4. The lift of claim 3, having:
a stowed arrangement in which each lift hinge is in the stowed position, the deck is in the stowed position, and the ramp is in the stowed position, the stowed arrangement facilitating introduction of the lift into a cabin of the aircraft, enabling storage of the lift within the cabin of the aircraft, enabling closure of a door of the aircraft, and facilitating removal of the lift from the cabin of the aircraft; and
a deployed arrangement in which each lift hinge is in the deployed position, the deck is in the deployed position, and the ramp is in the deployed position, the deployed arrangement enabling use of the lift to facilitate entry into and exit from the cabin of the aircraft.

5. The lift of claim 1, wherein at least one lift hinge of the pair of lift hinges further includes:
a lift drive engager that selectively engages and disengages the lift drive of the elongated lift leg that corresponds to the at least one lift hinge.

6. The lift of claim 1, further comprising:
a motor that operates the pair of elongated lift legs to move the deck along lengths of the pair of elongated lift legs.

7. The lift of claim 6, wherein the motor operates under power from the aircraft.

8. The lift of claim 6, further comprising:
a transfer case that enables the motor to simultaneously drive the pair of elongated lift legs.

9. The lift of claim 8, wherein the transfer case enables the motor to synchronously drive the pair of elongated lift legs.

10. The lift of claim 6, wherein the motor selectively drives movement of the pair of elongated lift legs through the pair of lift hinges.

11. The lift of claim 1, wherein the lift drive engager of each lift leg coupler of the deck can selectively engage and disengage the lift drive of the elongated lift leg that corresponds to the lift leg coupler.

12. The lift of claim 1, wherein each elongated lift leg can slide substantially freely through the lift leg receptacle of the lift hinge that corresponds to that elongated lift leg.

13. The lift of claim 1, wherein the base removably couples to a seat mounting structure of the aircraft.

14. A method for providing access to a cabin of an aircraft, comprising:
deploying a lift from within a cabin of an aircraft through a door of the aircraft, including:
pivoting a pair of lift hinges of the lift from a stowed position relative to a floor of the cabin of the aircraft and the door of the aircraft to a deployed position relative to the floor and the door;
extending a pair of elongated lift legs of the lift through the pair of lift hinges from a stowed position within the cabin of the aircraft to a deployed position outside of the door of the aircraft;
pivoting a deck of the lift from a stowed position substantially against the pair of elongated lift legs to a deployed position extending transversely from the pair of elongated lift legs; and
with the pair of lift hinges pivoted to the deployed position, the pair of elongated lift legs extended to the deployed position, and the deck of the lift pivoted to the deployed position, raising and/or lowering the deck along the pair of elongated lift legs.

15. The method of claim 14, wherein deploying the lift further includes:
after pivoting the deck of the lift from the stowed position to the deployed position, pivoting a ramp from a stowed position in which the ramp is folded over the deck to a deployed position in which the ramp extends from the deck.

16. The method of claim 15, wherein deploying the lift further includes:
locking the ramp in the deployed position.

17. The method of claim 14, wherein raising and/or lowering the deck comprises raising and/or lowering the deck under power from the aircraft.

18. The method of claim 14, further comprising:
stowing the lift, including:
lowering the deck along the pair of elongated lift legs;
pivoting the deck from the deployed position to the stowed position;
retracting the pair of elongated lift legs through the pair of lift hinges from the deployed position to the stowed position;
pivoting the pair of lift hinges from the deployed position to the stowed position; and
with the deck lowered, the deck pivoted to the stowed position, the pair of elongated lift legs retracted to the stowed position, and the pair of lift hinges pivoted to the stowed position, securing the lift in a stowed arrangement within the cabin of the aircraft.\

19. The method of claim 18, further comprising:
with the lift within the cabin in the stowed arrangement, closing the door of the aircraft.

20. The method of claim 18, comprising extending the pair of lift legs and retracting the pair of lift legs with a motor.
